(19) United States
(12) Patent Application Publication
(10) Pub. No.: US 2021/0354067 A1
(43) Pub. Date: Nov. 18, 2021

(54) Filter housing of a filter for fluid, latch and filter

(71) Applicant: MANN+HUMMEL GmbH, Ludwigsburg (DE)

(72) Inventor: Bradley Olson, Galesburg, MI (US)

(21) Appl. No.: 16/874,356

(22) Filed: May 14, 2020

(51) Int. Cl. B01D 46/00

(52) U.S. Cl. CPC B01D 46/0005; B01D 2279/60; B01D 2265/028

(57) ABSTRACT

A filter housing (12) has a first housing part (24) having at least one openable installation opening, at least one inlet opening for fluid to be cleaned, and at least one outlet opening for cleaned fluid. At least one second housing part (26 is configured to close off the at least one openable installation opening, and at least one latch (186) is configured to secure the at least one second housing part (26) in its closed position on the first housing part (24). The at least one latch (186) includes at least one lever element (188), at least one pulling element (190) and at least one elastic connecting element (192). The at least one lever element (188) is connected in a force-transmitting manner to one of the two housing parts (26) by means of at least one swivel mount (210) at least in the closed position. At least one pulling element (190) is connected in a force-transmitting manner to the lever element (188) at one end by means of at least one elastic connecting element (192). At least one pulling element (190) is connected in a force-transmitting manner to the other of the two housing parts (24) at the other end at least in the closed position.

### TECHNICAL FIELD

The invention relates to a filter housing of a filter for a fluid, the filter housing comprising a first housing part, which is comprising at least one openable installation opening, at least one inlet opening for fluid to be cleaned, and at least one outlet opening for cleaned fluid, at least one second housing part, which is configured to close off the at least one openable installation opening, and at least one latch, which is configured to secure the at least one second housing part in its closed position on the first housing part, wherein the first housing part comprising an element receptacle configured to receive, through the at least one openable installation opening in an installation direction which extends parallel or coaxially to an installation axis of the filter housing, at least one filter element, wherein the at least one filter element, when installed in the element receptacle, separates the at least one inlet opening from the at least one outlet opening.

Further the invention relates to a latch which is configured to secure at least one housing part of a filter housing in its closed position on another housing part of the filter housing.

Furthermore the invention relates to a filter for a fluid, which comprises a filter housing, in which at least one filter element is arranged exchangeable.

### BACKGROUND

The US 2018/0339254 A1 discloses a fluid filter has a filter housing with inlet opening for fluid to be cleaned and outlet opening for cleaned fluid. A filter element arranged in an element receptacle of the filter housing separates inlet opening from outlet opening. The filter housing has a housing body with an installation opening to the element receptacle, through which the filter element in an installation direction is introduced into the element receptacle. The filter housing has a housing cover for closing the installation opening. The installation opening is arranged in a transverse side of the housing body that is lateral relative to the housing axis. The filter housing has a sealing surface, surrounding the housing axis at least partially circumferentially, for contacting a seal of the filter element. The filter element has a seal support device for the seal and the filter housing has a pressing device for the seal support device. The at least one housing cover can be secured in its closed position on the housing body by means of a fastening and/or locking device, in particular at least one clamping fastener and/or at least one clasp.

### SUMMARY

The invention has the objective to configure a filter housing, a latch and a filter, in which the securing of one housing part to another housing part can be improved, in particular simplified.

The device is characterized in that at least one latch comprises at least one lever element, at least one pulling element and at least one elastic connecting element, wherein the at least one lever element is connected in a force-transmitting manner to one of the two housing parts by means of at least one swivel mount at least in the closed position, at least one pulling element is connected in a force-transmitting manner to the lever element at one end by means of at least one elastic connecting element and that at least one pulling element is connected in a force-transmitting manner to the other of the two housing parts at the other end at least in the closed position.

According to the invention, the installation opening of the first housing part can be closed by at least one second housing part. For securing the at least one second housing part in its closed position, the at least one latch has an elastic connecting element which is arranged between the at least one tension element and the at least one lever element. In this way, the elastic connecting element can be integrated into at least one lever element in a space-saving manner. The at least one elastic element allows the according housing part to remain secure through multiaxis movement. One advantage of the invention is the ability to use pulling elements that have an increased lifetime. Especially, the material of the pulling elements can be resistant against UV radiation, chemical action, corrosion, etc. Further, the length of the pulling elements can be easily customized especially with intelligently designed tooling. Furthermore, the inventive latch can be a cost-effective solution for securing two housing parts. Besides, the invention also allows for greater flexibility in packaging the filter housing in tight spaces, as the inventive latch that require only small clearances.

Advantageously, at least one elastic element can be a tensioner. In this way, a tension force can be realized by closing the at least one latch.

Advantageously, the first housing part can be a housing body. Advantageously, the second housing part can be a housing cover.

Advantageously, the at least one openable installation opening can be arranged in a transverse side of the first housing part and the transverse side can be lateral relative to a housing axis of the filter housing. This allows the filter housing to be arranged in a limited installation space so that the installation opening is freely accessible.

Advantageously, the first housing part can comprise at least one sealing surface for contact of at least one seal of the at least one filter element. In this way a clean side can be tightly separated from Aurora side.

Advantageously, the at least one sealing surface can surround the housing axis at least partially circumferentially. In this way the at least one sealing surface can be arranged centrally.

Advantageously, the filter housing can be designed for a filter for in particular gaseous fluid, in particular air, in particular of an internal combustion engine, in particular of a motor vehicle, comprises at least one inlet opening for fluid to be cleaned and at least one outlet opening for cleaned fluid. The filter housing comprises at least one second housing part with which an openable installation opening can be closed off. The at least one installation opening is arranged in a transverse side of the first housing part that is lateral relative to the housing axis. Further, the filter housing can comprise at least one pressing device configured to act on a seal support device of the at least one filter element.

In addition, the invention concerns a filter for in particular gaseous fluid, in particular air, in particular of an internal combustion engine, in particular of a motor vehicle, with at least one filter housing in which at least one filter element is arranged.

The invention can be used in motor vehicles, construction/agricultural machines, compressors, industrial motors or other devices with internal combustion engines.

Vehicles in the meaning of the invention can be land craft, watercraft and/or aircraft.

Advantageously, the motor vehicle can be a passenger car, a truck, a motorcycle, an autobus, a tractor, an agricultural vehicle and/or a construction vehicle or the like.

The invention can advantageously be part of an air intake manifold of an internal combustion engine. The filter can serve for cleaning combustion air to be supplied to the internal combustion engine. The invention is however not limited to an air filter of an air intake manifold of an internal combustion engine of a motor vehicle. Instead, it can also be used for other types of air systems of motor vehicles or other machines, in particular agricultural machines or construction machines. The air filter can also be used outside of the automotive field, in particular in industrial motors.

In a favorable embodiment, at least one elastic connecting element may be attached to the corresponding end of the at least one pulling element. In this way, the at least one connecting element can be connected to the at least one traction element in a captive manner.

Advantageously, the at least one elastic connecting element may be molded or formed in a corresponding and of the at least one pulling element. In this way, the at least one elastic connecting element can be realized easy and stable at the end of the at least one pulling element.

In another favorable embodiment, at least one elastic connecting element can be located in a receptacle of the lever element. The at least one elastic connecting element can be arranged in the receptacle to save space.

In another favorable embodiment, at least two elastic connecting elements can be arranged on opposite sides at the end of the at least one pulling element. In this way the force between the at least one lever element and the at least one pulling element can be transmitted more evenly.

In another favorable embodiment, the lever element can have at least one stop against which the at least one elastic connecting element can be supported with a stop section in the closed position against the pulling direction of the at least one pulling element. In this way, during a pull, at least one pulling element and at least one elastic connecting element can be supported against the lever element. In this way a corresponding lever force can be transferred from the lever element to the at least one pulling element.

In another favorable embodiment, at least one stop and/or the swivel mount can be located on the side facing away from an actuating section of the lever element. In this way, the lever conditions when operating the lever element can be improved.

In another favorable embodiment, at least one elastic connecting element can have a zigzag or wave shape. In this way, the at least one elastic connecting element can be deformed in a targeted manner, particularly in the pulling direction of the at least one pulling element.

In another favorable embodiment, at least one guide element can be arranged at the end of the at least one pulling element at which the at least one elastic connecting element is arranged, and the lever element can have a guide section in which the at least one guide element can be arranged so as to be guidable in and against the pulling direction of the at least one pulling element. In this way, the end of the at least one pulling element can be guided in or on the lever element. The at least one guide element can be moved in the guide section for this purpose. Advantageously, a guide section can be a part of the receptacle for the end of the pulling element.

In another favorable embodiment, the lever element can have a guide element stop against which the at least one guide element can be supported against the pulling direction of the at least one pulling element, and/or at least one elastic connecting element can be attached to at least one guide element. With the aid of the guide element stop, the freedom of movement of the at least one guide element can be restricted. Furthermore, in an end position force can be transmitted to the guide element stop via the at least one guide element. Advantageously, at least one elastic connecting element can be attached to at least one guide element. In this way a force transmission between the at least one elastic connecting element and the at least one guide element can be made possible.

In another favorable embodiment, the lever element can be separably connected to the corresponding housing part by means of a quick release swivel mount and/or the lever element can be connected to a cover housing part and/or the lever element can be separably connected to the pulling element.

The lever element can be easily and quickly separated from the corresponding housing part by means of a quick-release swivel mount. The lever element can be connected to the cover housing part. In this way, the lever element can be more easily accessible in the installation position of the filter housing. Advantageously, the lever element can also be separated. In this way, the cover housing part can be more easily separated from a housing body.

Advantageously, the lever element can be separably connected to the at least one pulling element. In this way the lever element can be manufactured separately from the at least one pulling element. Thus, different versions of tension elements, especially with different lengths, can be realized and connected modularly with the corresponding housing part.

In another favorable embodiment, at least two latches may be located on opposite sides of the at least one installation opening. In this way the latches can act uniformly on the at least one housing part. In this way a more uniform closing force can be achieved.

In another favorable embodiment, at least one pulling element can be flexible at least in sections. In this way, the shape of the at least one pulling element can adapt to the spatial conditions.

Advantageously, at least one pulling element can have or consist of a strap, a strip, wire or the like. In this way, the at least one pulling element can be realized in a space-saving and flexible manner.

Further the objective is solved for the filter by that the filter comprises a filter housing according to the invention.

Furthermore the objective is solved with the latch in accordance with the invention by that the latch comprises at least one lever element, at least one pulling element and at least one elastic connecting element, wherein the at least one lever element is connected in a force-transmitting manner to one of the two housing parts by means of at least one swivel mount at least in the closed position, at least one pulling element is connected in a force-transmitting manner to the lever element at one end by means of at least one elastic connecting element and that at least one pulling element is connected in a force-transmitting manner to the other of the two housing parts at the other end at least in the closed position.

In all other respects, the features and advantages shown in connection with the inventive housing body, the inventive latch and the inventive filter and their respective advantageous designs shall apply to each other accordingly and vice versa. The individual features and advantages can, of course, be combined with each other, whereby further advantageous effects can arise which are greater than the sum of the individual effects.

### BRIEF DESCRIPTION OF DRAWINGS

The present invention together with the above-mentioned and other objects and advantages may best be understood from the following detailed description of the embodiments, but not restricted to the embodiments, wherein is shown schematically

FIG. 1 a longitudinal section of an air filter with a filter housing in which exchangeably a filter element is arranged;

FIG. 2 an enlarged perspective view of the air filter from FIG. 1 showing the housing cover locked in place by two latches each comprising a pulling element, a lever element and two elastic connecting elements;

FIG. 3 an enlarged partial view one of the latches from FIG. 2;

FIG. 4 central section of a lever element of one of the latches from FIGS. 2 and 3;

FIG. 5 the central section of the lever element of FIG. 4 in another perspective;

FIG. 6 a detailed view of the pulling element and the elastic connecting elements of a latch from FIGS. 2 to 5.

In the drawings, equal or similar elements are referred to by equal reference numerals. The drawings are merely schematic representations, not intended to portray specific parameters of the invention. Moreover, the drawings are intended to depict only typical embodiments of the invention and therefore should not be considered as limiting the scope of the invention.

### DETAILED DESCRIPTION

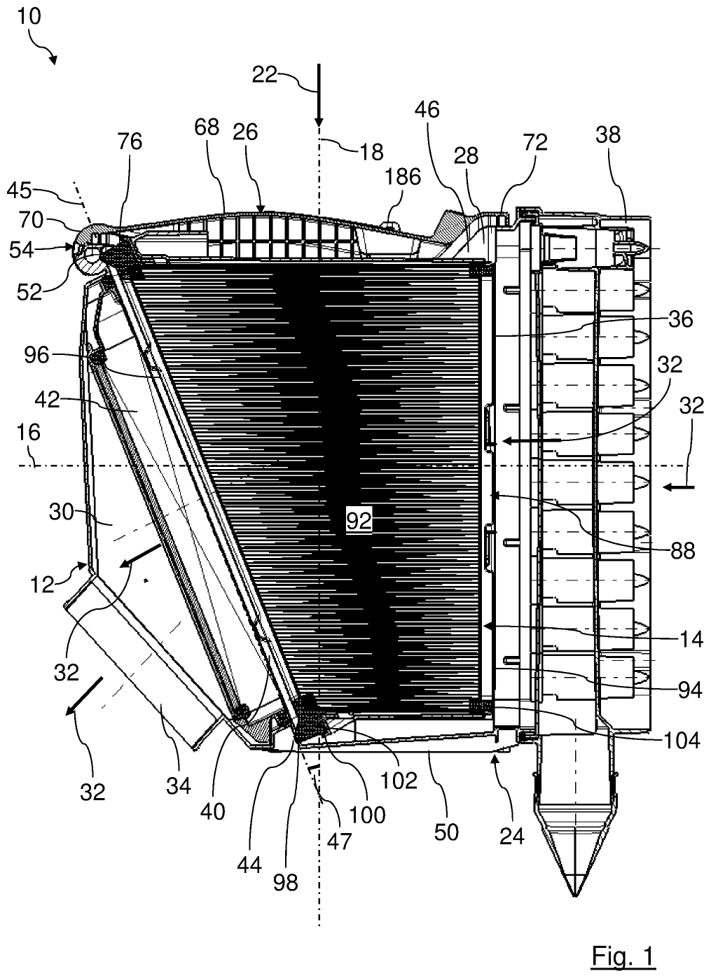

In the FIGS. 1 to 6, an air filter 10 for cleaning air or, for example, an internal combustion engine. The air filter 10 is illustrated in different illustrations, sections, detail views, and assembly states. The air filter 10 may serve for cleaning the combustion air which is supplied to the internal combustion engine for combustion. The air filter 10 may serve for cleaning air for other application, for example, air supply to a fuel cell providing electric power.

The air filter 10 comprises an openable filter housing 12 in which exchangeably a filter element 14 is arranged.

For simplifying the explanation, in some of the figures an imaginary main axis 16 and an installation axis 18 are illustrated. In an exemplary fashion, the installation direction 22 extends coaxial to the installation axis 18. It is understood that some of the aforementioned axes and some of the aforementioned planes can also extend at a slant to each other in other embodiments of the invention.

In the mounted state of the air filter 10, the main axis 16 coincides with the element axis of the filter element 14 and the housing axis of the filter housing 12 in the illustrated embodiment. For simplifying the drawing, the reference character 16 is therefore used for the element axis and the housing axis, depending on the illustration. It is understood that the corresponding axis is referred to, respectively, in this context. The same holds true also for the installation axis 18.

The filter housing 12 is manufactured of plastic material. The filter housing 12 comprises a housing body 24 and a housing cover 26.

The housing body 24 comprises an element receptacle 28 for the filter element 14. An air outlet space 30 adjoins the element receptacle 28 downstream relative to the air flow through the air filter 10. The air flow into, through, and out of the air filter 10 is illustrated in the FIG. 1 by arrows 32.

An outlet socket 34 to which the air conduit of the intake manifold is connected adjoins the air outlet space 30. At the air inlet side, the receptacle 28 comprises an inlet opening 36. The inlet opening 36 extends across the entire inflow side of the air filter 10. It extends parallel to the flow center plane. Upstream of the inlet opening 36, a cyclone arrangement 38 as pre-separator for particles from the air is arranged.

At its outflow side, the element receptacle 28 has an outlet opening 40. The outlet opening 40 extends in a plane parallel to the transverse axis 20 and at a slant to the flow center plane, i.e., at a slant to the plane of the inlet opening 36.

The element receptacle 28, the outlet opening 40 and the inlet opening 36 each have a rectangular cross section, viewed in the direction of the main axis 16.

In the air outlet space 30, a secondary filter element 42 is optionally arranged. The secondary filter element 42 covers the outlet opening 40 completely.

The outlet opening 40 is surrounded by a housing-associated sealing surface 44. The housing-associated sealing surface 44 is facing the element receptacle 28. Relative to the main axis 16, it is continuous circumferentially. A sealing plane 45 of the housing-associated sealing surface 44 extends at a slant to the flow center plane by an angle 47 of approximately 20 degrees.

The transverse sides of the housing body 24 and of the filter element 14 extend on opposite sides of the transverse center plane in the embodiment. Correspondingly, the longitudinal sides of the housing body 24 of the filter element 14 are positioned on opposite sides of the longitudinal center plane. The longitudinal sides of the housing body 24 and of the filter element 14 extend each between the corresponding transverse sides and the inflow side and the outflow side.

At the longitudinal sides, the housing body 24 comprises closed longitudinal walls 48.

At a rearward transverse side relative to the installation direction 22, the housing body 24 has an installation opening 46 for the filter element 14. At the transverse side that is positioned axially opposite thereto relative to the installation axis 18, the housing body 24 comprises a closed transverse wall 50.

The installation opening 46, viewed in installation direction 22, has an approximately rectangular cross section. Viewed in the installation direction 22 from the installation opening 46 toward the oppositely positioned transverse wall 50, the element receptacle 28 tapers in its expansion relative to the main axis 16. Viewed in the transverse direction of view in FIG. 1 which is perpendicular to axis 16 and axis 18, the element receptacle 28 has approximately the shape of a right angle trapezoid wherein the slanted leg of the trapezoid is facing the outlet opening 40.

At the exterior side of the housing body 24, adjacent to the installation opening 46, may include a bolt section 52 of a hinge-type pivot connection 54. The pivot connection 54 may serve for connecting the housing cover 26 with the housing body 24. The bolt section 52 is located at the side of the installation opening 26 which is facing the outflow side of the housing body 24. The bolt section 52 and thus the pivot axis of the pivot connection 54 extend parallel to the transverse direction perpendicular to axis 16 and the installation axis 18.

The bolt section 52 realizes a housing-body axis element of the pivot connection 54 on the side of the housing body 24. With the bolt section 52 the cover pivot axis of the pivot connection 54 is realized.

The housing cover 26 comprises a closure section 68 which forms the transverse side of the housing cover 26. A rim of the closure section 68 extending circumferentially relative to the installation axis 18 extends complementary to a corresponding rim surrounding the installation opening 46 of the housing body 24. The closure section 68 is resting in the closing position of the housing cover 26 seal-tightly against the installation opening 46 and closes it off.

At the side which is facing the outflow side of the filter housing 12, the housing cover 26 may comprise a U-shaped axle mounting element in form of sleeve section 70 which forms the cover-associated part of the pivot connection 54. The sleeve section 70 may extend parallel to the transverse axis. The sleeve section 70 may open at a circumferential side which is facing the inlet side of the filter housing 12 so that the sleeve section 70 for connecting the pivot connection 54 can be pushed onto the bolt section 52 in radial direction. Through the opening of the sleeve section 70 the bold section 52 can be inserted and withdrawn. The opening of the sleeve section 70 points to the side of the housing cover 26 where two latches 186 engage.

At the side which is facing the inflow side of the filter housing 12 and facing away from the sleeve section 70, the housing cover 26 comprises an actuating section 72. The housing cover 26 can be actuated at the actuating section 72 for closing or opening.

Moreover, the housing cover 26 may comprise two pressing blades (not shown) for pressing a seal 76 of the filter element 14 against the housing-associated sealing surface 44. The pressing blades are identical and arranged mirror-symmetrical to the longitudinal center plane.

The housing cover 26 is secured in its closing position, as illustrated in the 1 and 2, with two latches 186.

The latches 186 are located on opposite sides of the installation opening 204 46. The latches 186 are identically constructed.

The latches 186 each comprise a lever element 188, a pulling element 190 and two elastic connecting elements 192.

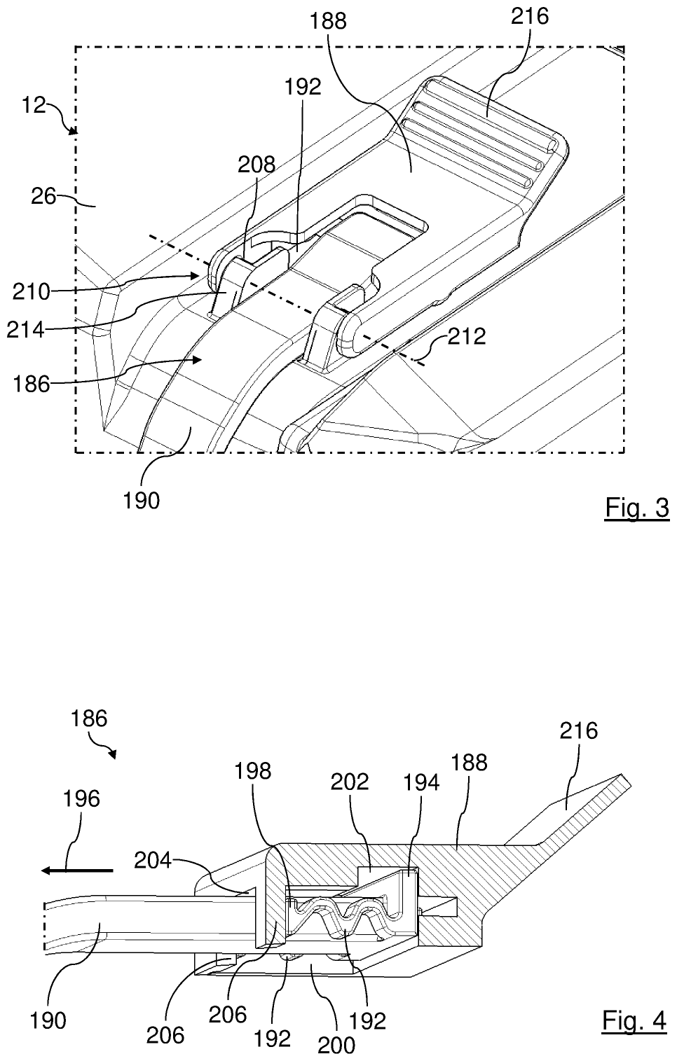

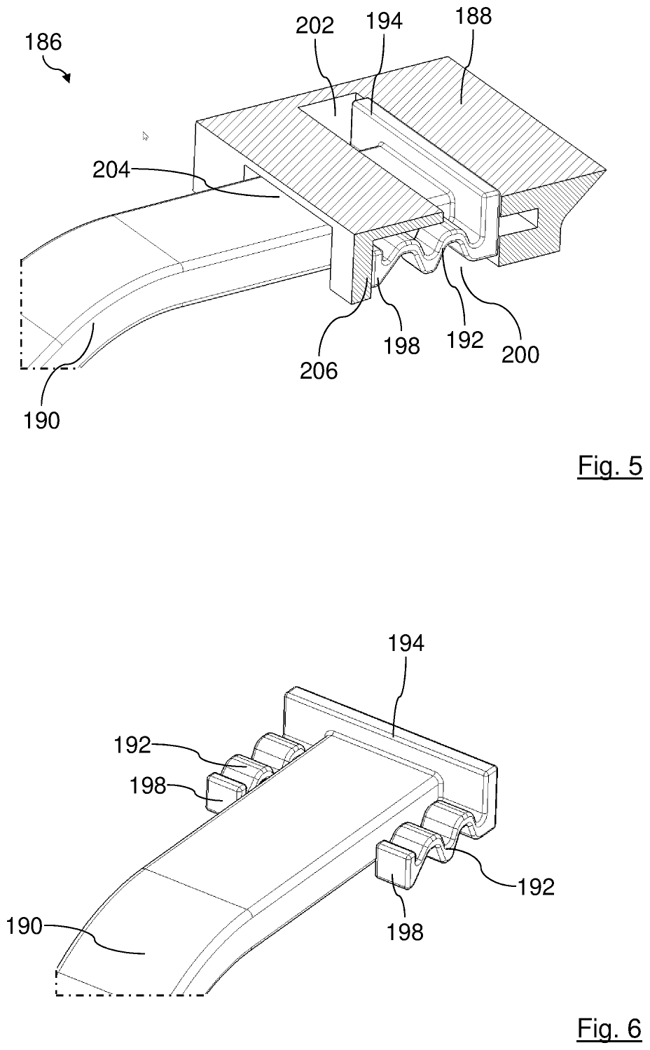

FIG. 3 shows a section of one of the latches 186 in the area of the lever element 188. FIGS. 4 and 5 each show central sections of the lever element 188 with the end of the pulling element 190.

The pulling element 190 is a flexible strap. As exemplary shown in FIG. 6 a guide element 194 is arranged in one piece at one end of the pulling element 190. The guide element 194 has a rectangular shape. The guide element 194 exceeds the pulling element 190 on the circumference.

On the end of the pulling element 190 with the guide element 194 the elastic connecting elements 192 are arranged on opposite sides. The elastic connecting elements 192 are attached for example by molding to the guide element 194 at the corresponding end of the pulling element 190. The elastic connecting elements 192 extend away from the guide element 194 against the pulling direction 196 parallel to the pulling element 190. The pulling direction one 196 is depicted in FIG. 4. The elastic connecting elements 192 each have a wave shape. The elastic connecting elements 192 can be laterally compressed in the pulling direction 196 of the pulling element 190.

The side of each elastic connecting element 192 which is opposite to the guide element 194 comprises a stop section 198.

The lever element 188 has a receptacle 200 for the end of the pulling element 190, the elastic connecting elements 192 and the guide element 194. In the receptacle 200 the elastic connecting elements 192 and the guide element 194 are allocated.

The lever element 188 has a guide section 202 for the guide element 194. The guide section 202 is a part of the receptacle 200. In the guide section 202 the guide element 194 is arranged so as to be guidable in and against the pulling direction 196 of the pulling element 190.

On one side the receptacle 200 has an opening 204 for the pulling element 190. On opposite sides of the opening 204 the lever element 188 has two guide element stops 206. Against the guide element stops 206 each one of the stop sections 198 of the guide elements 194 can be supported against the pulling direction 196 of the pulling element 190.

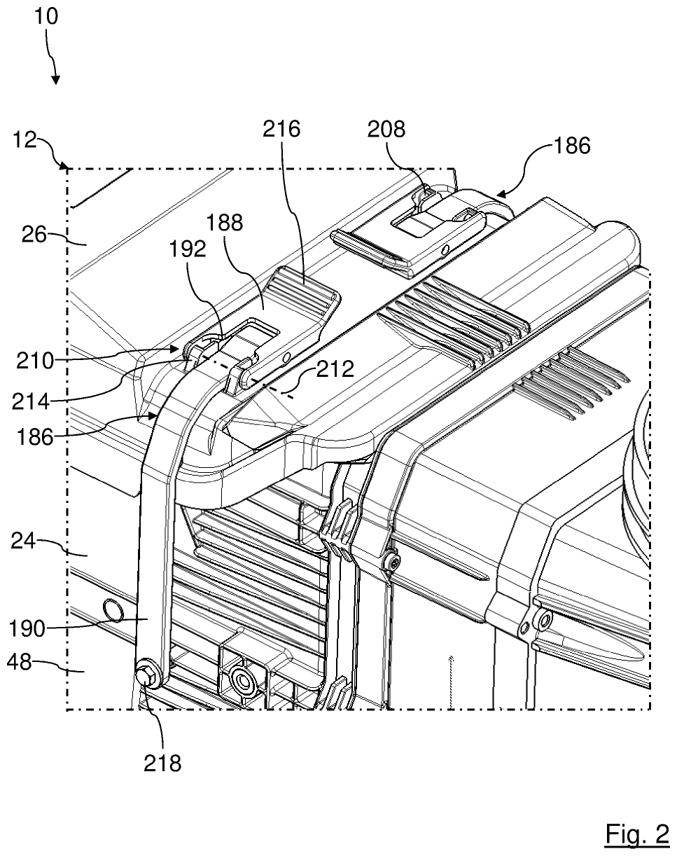

On the side with the opening 204 for the lever element 188 has two swivel pins 208, which are shown in FIGS. 2 and 3. The swivel pins 208 are part of a swivel mount 210. The lever element 188 is connected in a force-transmitting manner to the housing cover 26 by means of the swivel mount 210 in the closed position. The swivel pins 208 extent coaxially to a swivel axis 212 of the swivel mount 210. The swivel pins 208 each act together with a respective U-shaped swivel pin holder 214 of the swivel mount 210 on the side of the housing cover 26.

On the side of the lever element 188 facing away from the opening 204, the guide element stops 206 and the swivel mount 210 an actuating section 216 is located.

The pulling element 190 is connected separably in a force-transmitting manner to the lever element 188 by means of the elastic connecting elements 192 and the guide element 194.

The pulling element 190 is connected in a force-transmitting manner by means of a screw 218 to the housing body 24 at the other end.

The lever element 188 is separably connected to the housing cover 26 by means of the quick release swivel mount 210. The lever element 188 can be brought into its closed position, which is shown in the FIGS. 2 and 3, by pressing the actuating section 216. By pulling the actuating section 216, the lever element 188 can be moved to its opening position. In the opening position, the lever element 188 can be separated from the housing cover 26. Thus, the housing cover 26 can be opened.

The housing cover 26 is attached to the housing body 24 with the pivot connection 54. The pivot connection 54 and the latches 186 are on opposite sides of the installation opening 46. The housing cover 26 can be pivoted for giving the installation opening 46 free if the latches 186 are in the opening position.

The filter element 14 comprises a filter bellows 88 and may comprise a frame element circumferentially surrounding the filter bellows 88. The filter bellows 88 may be inserted into and may be fixed into an element frame. The filter bellows 88 comprises a zigzag-shaped folded filter medium 92. The filter bellows 88 is may be rectangular viewed in the direction of the main axis 16. Viewed in the direction of the transverse axis, the filter bellows 88 may have approximately the shape of a right angle trapezoid. An inflow side 94 of the filter bellows 88 extends parallel to the flow center plane, thus perpendicular to the main axis 16. An outflow side 96 extends parallel to the transverse axis and at a slant to the flow center plane, thus at a slant to the inflow side 94.

The filter bellows 88 may taper, viewed in installation direction 22, toward its forward transverse side. The fold edges of the filter medium 92 at the inflow side 94 and the outflow side 96 extend each parallel to the transverse axis. The fold edges define the inflow surface at the inflow side 94 and the outflow surface at the outflow side 96, respectively. The heights of the folds of the folded filter medium 92 in the direction of the main axis 16 may decrease from the transverse side of the filter bellows 88 that is rearward relative to the installation direction 22 toward its forward transverse side. The filter bellows 18 may thus have variable fold heights.

The outflow side 96 is surrounded by the seal 76. The seal 76 is made of polyurethane. It is elastic. The seal 76 is may be foamed onto the end face of the filter medium 92. The seal 76 may project past the filter medium 92 relative to the main axis 16 radially in outward direction and in axial direction. An outflow-associated end face sealing lip of the seal 76 forms a sealing surface 98 which is continuous circumferentially relative to the main axis 16. The sealing surface 98 in the installed state is resting against the housing-associated sealing surface 44.

At the rear side of the seal 76, which is facing away from the sealing surface 98 relative to the main axis 16, a reinforcement frame 100 of plastic material may be provided and embedded in the sealing bead of the seal 76. The reinforcement frame 100 may extend parallel to the sealing plane 44 and parallel to the sealing surface 98. The reinforcement frame 100 is preferentially continuous circumferentially relative to the main axis 16. A sealing rear side 102 of the seal 76, which is facing away axially from the sealing surface 98 relative to the main axis 16, may extend in a plane parallel to the plane of the sealing surface 98. With installed filter element 14, the respective planes of the sealing surface 98 and of the sealing rear side 102 preferably extend parallel to the sealing plane 45 of the housing-associated sealing surface 44.

Moreover, an edge protection 104 may be provided and fastened at the inflow side 94 of the filter bellows 88. The edge protection 104 may comprise polyurethane and foamed onto the filter medium 92. The edge protection 104 may extend continuously circumferentially relative to the main axis 16 along the inflow-associated rim of the filter bellows 88.

The edge protection 104 projects past the filter medium 92 relative to the main axis 16 in axial direction.

### LIST OF REFERENCE NUMBERS

10 Air filter
12 Filter housing
14 Filter element
16 Main axis
18 Installation axis
22 Installation direction
24 Housing body
26 Housing cover
28 Element receptacle
30 Air outlet space
32 Airflow
34 Outlet socket
36 Inlet opening
38 Cyclone arrangement
40 Outlet opening
42 Secondary filter element
44 Housing associated sealing surface
45 sealing plane
46 Installation opening
47 angle
48 Longitudinal walls
50 Transverse walls
52 Bolt section
53 cover pivot axis
54 Pivot connection
68 Closure section
70 Sleeve section
72 Actuating section
76 Seal
88 Filter bellow
92 Filter medium
94 Inflow side
96 Outflow side
98 Sealing surface
100 Reinforcement frame
102 Sealing rear side
104 Edge protection
186 latches
188 Lever element
190 Pulling element
192 Elastic connecting element
194 Guide element
196 Pulling direction
198 Stop section
200 Receptacle
202 Guide section
204 Opening
206 Guide element stops
208 Several pins
210 Swivel mount
212 Swivel axis
214 Swivel pin holder
216 Actuating section
218 Screw

What is claimed is:

1. A filter housing of a filter for a fluid, the filter housing comprising:
a first housing part, comprising
at least one openable installation opening;
at least one inlet opening for fluid to be cleaned; and
at least one outlet opening for cleaned fluid;
at least one second housing part, which is configured to close off the at least one openable installation opening; and
at least one latch, which is configured to secure the at least one second housing part in its closed position on the first housing part;
wherein the first housing part includes
an element receptacle configured to receive, through the at least one openable installation opening in an installation direction which extends parallel or coaxially to an installation axis of the filter housing, at least one filter element;
wherein the at least one filter element, when installed in the element receptacle, separates the at least one inlet opening from the at least one outlet opening;
wherein the at least one latch comprises
at least one lever element;
at least one pulling element; and
at least one elastic connecting element;
wherein the at least one lever element is connected in a force-transmitting manner to one of the two housing parts by means of at least one swivel mount at least in the closed position;
wherein the at least one pulling element is connected in a force-transmitting manner to the lever element at one end by means of at least one elastic connecting element; and
wherein the at least one pulling element is connected in a force-transmitting manner to the other of the two housing parts at the other end at least in the closed position.

2. The filter housing according to claim 1, wherein
the at least one elastic connecting element is attached to a corresponding end of the at least one pulling element.

3. The filter housing according to claim 2, wherein
the at least one elastic connecting element is located in a receptacle of the lever element.

4. The filter housing according to claim 1, wherein
the at least one elastic connecting element is at least two elastic connecting elements arranged on opposite sides at the end of the at least one pulling element.

5. The filter housing according to claim 4, wherein
the lever element includes at least one stop against which the at least one elastic connecting element can be supported with a stop section in the closed position against the pulling direction of the at least one pulling element.

6. The filter housing according to claim 5, wherein
the at least one stop and/or the swivel mount is located on a side of the lever element facing away from an actuating section of the lever element.

7. The filter housing according to claim 1, wherein
the at least one elastic connecting element has a zigzag or wave shape.

8. The filter housing according claim 1, wherein
at least one guide element is arranged at an end of the at least one pulling element at which the at least one elastic connecting element is arranged; and
the lever element has a guide section in which the at least one guide element is arranged so as to be guidable in and against the pulling direction of the at least one pulling element.

9. The filter housing according claim 8, wherein
the lever element has a guide element stop against which the at least one guide element can be supported against the pulling direction of the at least one pulling element, and/or
at least one elastic connecting element is attached to at least one guide element.

10. The filter housing according to claim 1, wherein
the lever element is separably connected to a corresponding housing part by means of a quick release swivel mount; and/or
the lever element is connected to a cover housing part; and/or
the lever element is separably connected to the pulling element.

11. The filter housing according to claim 1, wherein
wherein the at least one latch is at least two latches;
wherein two latches of the at least two latches are located on opposite sides of the at least one installation opening.

12. The filter housing according to claim 1, wherein
the at least one pulling element is flexible at least in sections.

13. A filter for a fluid, comprising:
a filter housing according to claim 1;
wherein at least one filter element is arranged in the filter housing.

14. A latch which is configured to secure at least one housing part of a filter housing in its closed position on another housing part of the filter housing, the latch comprising:
at least one lever element;
at least one pulling element; and
at least one elastic connecting element;
wherein the at least one lever element is connected in a force-transmitting manner to one of the two housing parts by means of at least one swivel mount at least in the closed position;
the at least one pulling element is connected in a force-transmitting manner to the lever element at one end by means of at least one elastic connecting element; and
the at least one pulling element is connected in a force-transmitting manner to a different one of the two housing parts at the other end at least in the closed position.
